(19) United States
(12) Patent Application Publication
(10) Pub. No.: US 2025/0299025 A1
(43) Pub. Date: Sep. 25, 2025

(54) METHOD AND DEVICE FOR IMPLEMENTING INFERENCE OF NEURAL NETWORK MODEL

(71) Applicant: SAMSUNG ELECTRONICS CO., LTD., Suwon-si (KR)

(72) Inventors: Peng WANG, Suwon-si (JP); Linxuan LIU, Suwon-si (KR); Tao PENG, Suwon-si (KR)

(73) Assignee: SAMSUNG ELECTRONICS CO., LTD., Suwon-si (KR)

(21) Appl. No.: 18/659,888

(22) Filed: May 9, 2024

(30) Foreign Application Priority Data
Mar. 20, 2024 (CN) 202410324744.2

(51) Int. Cl. G06N 3/0464; G06N 3/084

(52) U.S. Cl. CPC G06N 3/0464; G06N 3/084

(57) ABSTRACT

A method includes performing, in a rich execution environment, computation for each convolution layer of a neural network model, based on multiplicative perturbation factors of the convolution layer and outputting a computation result of each layer to a trusted execution environment (TEE), and in the TEE, correcting the computation result of a first layer of the layers based on the multiplicative perturbation factors, correcting the computation result of each remaining layer other than the first layer based on the multiplicative perturbation factors and intermediate result protection (IRP) noise correction factors corresponding to the remaining layer, inputting the corrected computation results of the layers into corresponding nonlinear layers of the neural network model, and applying IRP noise to an output of the nonlinear layer corresponding to each convolution layer other than a last convolution layer, and outputting the nonlinear layer to which the IRP noise has been applied to the REE.

### CROSS-REFERENCE TO RELATED APPLICATIONS

This application is based on and claims priority under 35 U.S.C. § 119 to Chinese Patent Application No. 202410324744.2, filed on Mar. 20, 2024, in the China National Intellectual Property Administration, the disclosure of which being incorporated by reference herein in its entirety.

### BACKGROUND

### 1. Field

The present disclosure relates to confidential computing, and more specifically, to a method and device for implementing inference of a neural network model.

### 2. Description of the Related Art

When a neural network model is used for performing inference computations, data of the model needs to be decrypted into memory or an AI accelerator, so that the model exists in the memory or peripheral devices in plaintext. However, there are disadvantages in that the data of the model in plaintext may be easily obtained by attackers.

In order to protect the data of the model, an additive perturbation may be applied to the model, and computation for the perturbed model may be executed in a rich execution environment (REE). A computation result of the perturbed model may be corrected, intermediate result protection (IRP) noise may be applied to the corrected computation result in a trusted execution environment (TEE), and the result to which the IRP noise has been applied is passed back to a next layer of the perturbed model for executing computation.

However, there are still disadvantages in that the correcting for the computation result in the TEE requires a large amount of computation, and the application of the IRP noise may also allow the data of the model to be easily intercepted.

Therefore, how to reduce an amount of inference computation of the neural network model and better protect the data of the model is an issue that needs to be addressed urgently.

### SUMMARY

It is an aspect to provide a method and device for implementing inference of a neural network model to address at least one of the above disadvantages in the related art. However, embodiments are not required to address the above disadvantages and some embodiments may not address any of the above disadvantages.

According to an aspect of one or more exemplary embodiments, there is provided a method for implementing inference of a neural network model, the method comprising performing, in a rich execution environment (REE), computation for each of a plurality of convolution layers of the neural network model, based on multiplicative perturbation factors of the convolution layer and outputting a computation result of each of the plurality of convolution layers to a trusted execution environment (TEE); and in the trusted execution environment (TEE): correcting the computation result of a first convolution layer of the plurality of convolution layers based on the multiplicative perturbation factors corresponding to the first convolution layer, correcting the computation result of each of remaining convolution layers other than the first convolution layer among the plurality of convolution layers based on the multiplicative perturbation factors and intermediate result protection (IRP) noise correction factors corresponding to the remaining convolution layers, inputting the corrected computation result of the plurality of convolution layers into corresponding nonlinear layers of the neural network model, and applying IRP noise to an output of the nonlinear layer corresponding to each of the plurality of convolution layers other than a last convolution layer among the plurality of convolution layers, and outputting the nonlinear layer to which the IRP noise has been applied to the REE, wherein the IRP noise correction factors are based on IRP noise applied to the output of the nonlinear layer corresponding to a previous convolution layer of the remaining convolution layers, and wherein an output of a last nonlinear layer of the neural network model is an inference result of the neural network model.

According to another aspect of one or more exemplary embodiments, there is provided a neutral network model inference device comprising at least one first memory that stores first computer code; at least one first processor that accesses the at least one first memory and executes the first computer code to implement at least computing module configured to perform, in a rich execution environment (REE), computation for each of a plurality of convolution layers of a neural network model, based on multiplicative perturbation factors of the convolution layer and output a computation result of each of the plurality of convolution layers to a trusted execution environment (TEE); at least one second memory in a trusted execution environment (TEE) that stores second computer code; and at least one second processor in the TEE that accesses the at least one second memory in the TEE and executes the second computer code in the TEE to implement at least: a correcting module configured to, in the trusted execution environment (TEE), correct the computation result of a first convolution layer of the plurality of convolution layers based on the multiplicative perturbation factors corresponding to the first convolution layer, and correct the computation result of each of remaining convolution layers other than the first convolution layer among the plurality of convolution layers based on the multiplicative perturbation factors and intermediate result protection (IRP) noise correction factor corresponding to the remaining convolution layer; an inputting module configured to, in the TEE, input the corrected computation result of the plurality of convolution layers into corresponding nonlinear layers of the neural network model; and an applying module configured to, in the TEE, apply IRP noise to an output of the nonlinear layers corresponding to each of the plurality of convolution layers other than a last layer among the plurality of convolution layers, and output the nonlinear layer to which the IRP noise has been applied to the REE, wherein the IRP noise correction factors are based on IRP noise applied to the output of the nonlinear layer corresponding to a previous convolution layer of the remaining convolution layers, and wherein an output of a last nonlinear layer of the neural network model is an inference result of the neural network model.

According to yet another aspect of one or more exemplary embodiments, there is provided a non-transitory computer readable storage medium storing a computer program that when executed by at least one processor causes the at least one processor to at least perform, in a rich execution environment (REE), computation for each of a plurality of convolution layers of a neural network model, based on multiplicative perturbation factors of the convolution layer and output a computation result of each of the plurality of convolution layers to a trusted execution environment (TEE); and in the trusted execution environment (TEE): correct the computation result of a first convolution layer of the plurality of convolution layers based on the multiplicative perturbation factors corresponding to the first convolution layer, correct the computation result of each of remaining convolution layers other than the first convolution layer among the plurality of convolution layers based on the multiplicative perturbation factors and intermediate result protection (IRP) noise correction factors corresponding to the remaining convolution layers, input the corrected computation result of the plurality of convolution layers into corresponding nonlinear layers of the neural network model, and applying IRP noise to an output of the nonlinear layer corresponding to each of the plurality of convolution layers other than a last convolution layer among the plurality of convolution layers, and outputting the nonlinear layer to which the IRP noise has been applied to the REE, wherein the IRP noise correction factors are based on IRP noise applied to the output of the nonlinear layer corresponding to a previous convolution layer of the remaining convolution layers, and wherein an output of a last nonlinear layer of the neural network model is an inference result of the neural network model.

### BRIEF DESCRIPTION OF DRAWINGS

The above and other aspects will become more apparent through the following descriptions made in conjunction with the drawings, in which:

FIG. 1 illustrates a schematic diagram of an example of an inference computation for a convolution layer of a neural network model based on an additive perturbation;

FIG. 2 illustrates a flowchart of a method for implementing inference of a neural network model according to some embodiments;

FIG. 3 illustrates a schematic diagram of an example of performing multiplicative perturbation on a particular layer of a neural network model based on multiplicative perturbation factors, according to some embodiments;

FIG. 4 illustrates a schematic diagram of a process of performing correcting, limiting, non-linear computing, and applying of intermediate result protection (IRP) noise on a computation result in the REE of the Ith particular layer in a TEE according to some embodiments; and

FIG. 5 illustrates a block diagram of a structure of a device for implementing inference of a neural network model according to some embodiments.

### DETAILED DESCRIPTION

Hereinafter, various embodiments are described with reference to the accompanying drawings, in which like reference numerals are used to depict the same or similar elements, features, and structures. However, the present disclosure is not intended to be limited by the various embodiments described herein, and it is intended that the present disclosure covers all modifications, equivalents, and/or alternatives of the present disclosure that come within the scope of the appended claims and their equivalents. The terms and words used in the following description and claims are not limited to their dictionary meanings, but, are merely used to enable a clear and consistent understanding of the present disclosure. Accordingly, it should be apparent to those skilled in the art that the following description of various embodiments are provided for illustration purposes only and not for the purpose of limiting the present disclosure as defined by the appended claims and their equivalents.

It is to be understood that the singular forms include plural forms, unless the context clearly dictates otherwise. The terms “include,” “include,” and “have”, used herein, indicate disclosed functions, operations, or the existence of elements, but does not exclude other functions, operations, or elements.

For example, the expressions “A or B,” or “at least one of A and/or B” may include within their scope “A and B,” “only A,” and “only B.” For instance, the expression “A or B” or “at least one of A and/or B” may indicate (1) A, (2) B, or (3) both A and B.

In various embodiments of the present disclosure, it is intended that when a component (for example, a first component) is referred to as being “coupled” or “connected” with/to another component (for example, a second component), the component may be directly connected to the other component or may be connected through another component (for example, a third component).In contrast, when a component (for example, a first component) is referred to as being “directly coupled” or “directly connected” with/to another component (for example, a second component), another component (for example, a third component) does not exist between the component and the other component.

The expression “configured to”, used in describing various embodiments of the present disclosure, may be used interchangeably with expressions such as “suitable for,” “having the capacity to,” “designed to,” “adapted to,” “made to,” and “capable of”, for example, according to the situation. The term “configured to” may not necessarily indicate “specifically designed to” in terms of hardware. Instead, the expression “a device configured to” in some situations may indicate that the device and another device or part are “capable of.” For example, the expression “a processor configured to perform A, B, and C” may indicate a dedicated processor (for example, an embedded processor) for performing a corresponding operation or a general purpose processor (for example, a central processing unit (CPU) or an application processor (AP)) for performing corresponding operations by executing at least one software program stored in a memory device.

The terms used herein are used to describe certain embodiments, but are not intended to limit the scope of other embodiments. Unless otherwise indicated herein, all terms used herein, including technical or scientific terms, may have the same meanings that are generally understood by a person skilled in the art. In general, terms defined in a dictionary should be considered to have the same meanings as the contextual meanings in the related art, and, unless clearly defined herein, should not be understood differently or as having an excessively formal meaning. In any case, even terms defined in the present disclosure are not intended to be interpreted as excluding embodiments of the present disclosure.

According to an aspect of one or more exemplary embodiments, a method for implementing inference of a neural network model may include obtaining perturbation parameters of each of a first plurality of particular layers of the neural network model by performing multiplicative perturbation on actual parameters of the each particular layer based on multiplicative perturbation factors corresponding to the each particular layer, wherein the each particular layer is a convolution layer or a fully connected layer; performing, in a rich execution environment (REE), computation for the each particular layer based on the perturbed parameters of the each particular layer; and in a trusted execution environment (TEE), correcting a computation result of a first particular layer of the first plurality of particular layers based on the multiplicative perturbation factors corresponding to the first particular layer, correcting a computation result of each of a second plurality of particular layers other than the first particular layer among the first plurality of particular layers based on the multiplicative perturbation factors and intermediate result protection (IRP) noise correction factors corresponding to the each of the second plurality of particular layers, inputting the corrected computation result of the each of the first plurality of particular layers into a nonlinear layer corresponding to the each of the first plurality of particular layers of the neural network model, and applying IRP noise to an output of the nonlinear layer corresponding to each of a third plurality of particular layers other than the last particular layer among the first plurality of particular layers, wherein the IRP noise correction factors corresponding to the each of the second plurality of particular layers are determined based on IRP noise applied to an output of a nonlinear layer corresponding to a previous particular layer of the each of the second plurality of particular layers, wherein the output of the non-linear layer corresponding to the each of the third plurality of particular layers to which the IRP noise has been applied is an input to a next particular layer of the each of the third plurality of particular layers, and wherein an output of the last nonlinear layer of the neural network model is an inference result of the neural network model.

According to some embodiments, since an amount of inference computation based on multiplicative perturbation is much smaller than that based on additive perturbation, an overhead of correction for the perturbation is effectively controlled. The present disclosure may implement perturbation on parameters of all convolution layers and all fully connected layers in the model without deterioration of performance, so that the problem of having to sacrifice the security and leak part of weights in order to improve computation performance in the related technology may be solved.

In some embodiments, the obtaining of the perturbed parameters of the each particular layer may include determining a vector λ=[λ₁, λ₂, . . . , λ_{d}] of the multiplicative perturbation factors corresponding to convolution kernels of the each of the first plurality of particular layers, wherein respective perturbation factors in the vector of the perturbation factors follow a distribution defined by following equations:

$$E [ {λ}_{s} ] = 0 ,$$

$$Var [ {λ}_{s} ] = \frac{{G}^{2} \cdot {D}_{t}}{{max}_{i} {\vert {w}_{i} \vert}^{2}} ,$$

wherein d denotes a number of the convolution kernels of the each of the first plurality of particular layers, E[λₛ] and Var[λₛ] denote a mean and a variance of the sth perturbation factor in the vector of the multiplicative perturbation factors, respectively, G denotes an activation function gain value, Dₜ denotes an expected attenuation of a gradient variance as the gradient variance propagates backward in the each of the first plurality of particular layers, and wᵢ denotes a vector formed by weights over channels of the ith convolution kernel in W, W denotes a weight matrix for all convolution kernels of the each of the first plurality of particular layers, s=1, 2, . . . , d; and the obtaining of the perturbed parameters of the each particular layer may further include obtaining perturbed weights and perturbed biases of the convolution kernels of the each of the first plurality of particular layers by performing multiplicative perturbation on actual weights and actual biases of the convolution kernels of the each of the first plurality of particular layers based on the vector of the perturbation factors corresponding to the convolution kernels of the each of the first plurality of particular layers.

According to some embodiments, a correlation between a computation result of a convolution kernel of a model perturbed based on the multiplicative perturbation factors of the present disclosure and a true computational result of the convolution kernel of a model that is not perturbed during forward propagation of the model is zero, that is, the two computation results are linearly independent. This linear independence means that the perturbation plays a sufficient role so that an attacker may be prevented from intercepting the data of the model based on a relationship between the perturbed computation result and the true computation result.

In some embodiments, the obtaining of the perturbation parameters of the each particular layer further includes, when the each of the first plurality of particular layers is a convolution layer, before obtaining the perturbed weights and the perturbed biases of the convolution kernels of the each of the first plurality of particular layers by performing the multiplicative perturbation on the actual weights and the actual biases of the convolution kernels of the each of the first plurality of particular layers based on the vector of the perturbation factors corresponding to the convolution kernels of the each of the first plurality of particular layers, updating the actual weights and the actual biases of the convolution kernels of the each of the first plurality of particular layers based on the actual parameters of the each of the first plurality of particular layers and parameters of a batch normalization (BN) layer corresponding to the each of the first plurality of particular layers of the neural network model; and deleting the BN layer or initializing the parameters of the BN layer, and wherein the obtaining of the perturbed weights and the perturbed biases of the convolution kernels of the each of the first plurality of particular layers by performing the multiplicative perturbation on the actual weights and the actual biases of the convolution kernels of the each of the first plurality of particular layers based on the vector of the perturbation factors corresponding to the convolution kernels of the each of the first plurality of particular layers includes: obtaining the perturbed weights and the perturbed biases the convolution kernels of the each of the first plurality of particular layers by performing the multiplicative perturbation on the updated actual weights and the updated actual biases of the convolution kernels of the each of the first plurality of particular layers based on the vector of the perturbation factors corresponding to the convolution kernels of the each of the first plurality of particular layers.

In some embodiments, the updating of the actual weights and the actual biases of the convolution kernels of the each of the first plurality of particular layers includes: obtaining the updated weights \tilde{W} and the updated biases \tilde{B} of the convolution kernels of the each of the first plurality of particular layers based on following equations:

$$\tilde{W} = \frac{γ W}{\sqrt{{σ}^{2} + ϵ}} , \tilde{B} = β J + γ \frac{B - μ J}{\sqrt{{σ}^{2} + ϵ}} ,$$

wherein W and B denote the actual weights and the actual biases of the convolution kernels of the each of the first plurality of particular layers respectively, γ, β, μ, σ and ϵ are parameters of the BN layer, and J denotes an all-ones matrix.

According to some embodiments, parameters of the BN layer reflect statistical properties of an output of the corresponding convolution kernel and are helpful for the attacker to explore the model in reverse, so fusing parameters of the two layers firstly before perturbing the model and initializing original parameters of the BN layer at the same time may both conceal the actual parameters of the BN layer, and force the attacker to start from a fully initialized state when re-training the BN layer.

In some embodiments, the method may further include calculating |ξ| that is a modulus of a vector ξ formed by squares of perturbation factors in the vector of the perturbation factors corresponding to the convolution kernels of the each of the first plurality of particular layers; and updating the vector of the perturbation factors corresponding to the convolution kernels of the each of the first plurality of particular layers to be

$$λ \cdot \sqrt{\frac{M}{\vert ξ \vert}}$$

when |ξ| is greater than M, wherein

$$M = \frac{{G}^{2} \cdot {D}_{t}}{{max}_{i} \vert {m}_{i} \vert} ,$$

mᵢ=[|wᵢ₁|², |wᵢ₂|², . . . |w_{id}|²], wᵢₛ denotes a vector formed by weights over the ith channel of the sth convolution kernel of the each of the first plurality of particular layers, s=1, 2, . . . , d.

According to some embodiments, the model perturbed based on the updated perturbation factors facilitates layer-by-layer decay of the variance of the gradient during back propagation. This facilitation of layer-by-layer decay prevents a shallow network from getting rich gradient updates when the attacker performs training based on the perturbed model, thereby reducing expressiveness of the model.

In some embodiments, the method may further include, before the inputting of the corrected computation result of the each of the first plurality of particular layers into the nonlinear layer corresponding to the each of the first plurality of particular layers of the neural network model, updating the corrected computation result to be a first threshold if the corrected computation result is not greater than a first threshold, and updating the corrected computation result to be a second threshold if the corrected computation result is greater than the second threshold, wherein the first threshold and the second threshold are determined based on parameters of the BN layer corresponding to the each of the first plurality of particular layers.

In some embodiments, the first threshold d and the second threshold u may be obtained based on following equations:

$$d = - k γ + β , u = k γ + β ,$$

wherein γ and β are the parameters of the BN layer corresponding to the each of the first plurality of particular layers, and k is a preset value.

According to some embodiments, a stable and sufficiently low signal-to-noise ratio between the input signal and the IRP noise may be maintained by limiting amplitude of the input signal, which may prevent the attacker from intercepting parameters of the model by inputting a sufficiently large signal.

In some embodiments, the applied IRP noise may cause a correlation between the computation result of the each of the third plurality of particular layers in the REE and an output of the non-linear layer corresponding to the each of the third plurality of particular layers to which the IRP noise has been applied to be less than a predetermined value.

In some embodiments, the IRP noise e applied to the output of the non-linear layer may be obtained based on following equation:

$$e = r + c ,$$

wherein respective elements of r are independent from each other and follow an identical distribution, and r is Gaussian white noise with a mean of 0 and a variance of not less than Dₘᵢₙ, where

$${D}_{min} = ( \frac{1}{{ρ}_{x , y}^{2}} - 1 ) \cdot {( \frac{b - a}{2} )}^{2} ,$$

c denotes random samples on an interval [a,b], wherein ρ_{x,y} is a preconfigured Pearson's correlation coefficient, wherein a is obtained by mapping of the first threshold through a nonlinear layer and b is obtained by mapping of the second threshold through the nonlinear layer.

In some embodiments, a weak correlation between the computational result of a particular layer in the REE and the output of the nonlinear layer to which the IRP noise has been applied may be implemented by applying suitable IRP noise, which may prevents the attacker from obtaining intact perturbation factors.

In some embodiments, τ that is a vector of the IRP noise correction factors corresponding to the each of the second plurality of particular layers may be obtained based on following equation:

τ=Conv(e, Ŵ), wherein e denotes IRP noise applied to an output of a nonlinear layer corresponding to a previous particular layer of the each of the second plurality of particular layers, and Ŵ denotes weights of convolution kernels of the each of the second plurality of particular layers that have been perturbed.

According to some embodiments, a device for implementing inference of a neural network model may include an obtaining unit configured to obtain perturbation parameters of each of a first plurality of particular layers of the neural network model by performing multiplicative perturbation on actual parameters of the each particular layer based on multiplicative perturbation factors corresponding to the each particular layer, wherein the each particular layer is a convolution layer or a fully connected layer; a computing unit configured to perform, in a rich execution environment (REE), computation for the each particular layer based on the perturbed parameters of the each particular layer; a correcting unit configured to, in a trusted execution environment (TEE), correct a computation result of a first particular layer of the first plurality of particular layers based on the multiplicative perturbation factors corresponding to the first particular layer, and correct a computation result of each of a second plurality of particular layers other than the first particular layer among the first plurality of particular layers based on the multiplicative perturbation factors and intermediate result protection (IRP) noise correction factors corresponding to the each of the second plurality of particular layers; an inputting unit configured to, in the TEE, input the corrected computation result of the each of the first plurality of particular layers into a nonlinear layer corresponding to the each of the first plurality of particular layers of the neural network model; and an applying unit configured to, in the TEE, apply IRP noise to an output of the nonlinear layer corresponding to each of a third plurality of particular layers other than the last particular layer among the first plurality of particular layers, wherein the IRP noise correction factors corresponding to the each of the second plurality of particular layers are determined based on IRP noise applied to an output of a nonlinear layer corresponding to a previous particular layer of the each of the second plurality of particular layers, wherein the output of the non-linear layer corresponding to the each of the third plurality of particular layers to which the IRP noise has been applied is an input to a next particular layer of the each of the third plurality of particular layers, and wherein an output of the last nonlinear layer of the neural network model is an inference result of the neural network model.

In some embodiments, the obtaining unit may be configured to determine a vector λ=[λ₁, λ₂, . . . , λ_{d}] of the perturbation factors corresponding to convolution kernels of the each of the first plurality of particular layers, wherein respective perturbation factors in the vector of the perturbation factors follow a distribution defined by following equations:

$$E [ {λ}_{s} ] = 0 ,$$

$$Var [ {λ}_{s} ] = \frac{{G}^{2} \cdot {D}_{t}}{{max}_{i} {\vert {w}_{i} \vert}^{2}} ,$$

wherein d denotes a number of the convolution kernels of the each of the first plurality of particular layers, E[λₛ] and Var[λₛ] denote a mean and a variance of the sth perturbation factor in the vector of the perturbation factors, respectively, G denotes an activation function gain value, Dₜ denotes an expected attenuation of a gradient variance as it propagates backward in the each of the first plurality of particular layers, and wᵢ denotes a vector formed by weights over channels of the ith convolution kernel in W, W denotes a weight matrix for all convolution kernels of the each of the first plurality of particular layers, s=1, 2, . . . , d; and obtain perturbed weights and perturbed biases of the convolution kernels of the each of the first plurality of particular layers by performing multiplicative perturbation on actual weights and actual biases of the convolution kernels of the each of the first plurality of particular layers based on the vector of the perturbation factors corresponding to the convolution kernels of the each of the first plurality of particular layers.

In some embodiments, the obtaining unit may be further configured to, when the each of the first plurality of particular layers is a convolution layer, before obtaining the perturbed weights and the perturbed biases of the convolution kernels of the each of the first plurality of particular layers by performing the multiplicative perturbation on the actual weights and the actual biases of the convolution kernels of the each of the first plurality of particular layers based on the vector of the perturbation factors corresponding to the convolution kernels of the each of the first plurality of particular layers, update the actual weights and the actual biases of the convolution kernels of the each of the first plurality of particular layers based on the actual parameters of the each of the first plurality of particular layers and parameters of a batch normalization (BN) layer corresponding to the each of the first plurality of particular layers of the neural network model; and delete the BN layer or initializing the parameters of the BN layer, and wherein the obtaining unit is configured to obtain the perturbed weights and the perturbed biases the convolution kernels of the each of the first plurality of particular layers by performing the multiplicative perturbation on the updated actual weights and the updated actual biases of the convolution kernels of the each of the first plurality of particular layers based on the vector of the perturbation factors corresponding to the convolution kernels of the each of the first plurality of particular layers.

In some embodiments, the obtaining unit may be configured to: obtain the updated weights \tilde{W} and the updated biases \tilde{B} of the convolution kernels of the each of the first plurality of particular layers based on following equations:

$$\tilde{W} = \frac{γ W}{\sqrt{{σ}^{2} + ϵ}} , \tilde{B} = β J + γ \frac{B - μ J}{\sqrt{{σ}^{2} + ϵ}} ,$$

wherein W and B denote the actual weights and the actual biases of the convolution kernels of the each of the first plurality of particular layers respectively, γ, β, μ, σ and ϵ are parameters of the BN layer, and J denotes an all-ones matrix.

In some embodiments, the device may further include a first updating unit configured to calculate |ξ| that is a modulus of a vector ξ formed by squares of perturbation factors in the vector of the perturbation factors corresponding to the convolution kernels of the each of the first plurality of particular layers; and update the vector of the perturbation factors corresponding to the convolution kernels of the each of the first plurality of particular layers to be

$$λ \cdot \sqrt{\frac{M}{\vert ξ \vert}}$$

when |ξ| is greater than M, wherein

$$M = \frac{{G}^{2} \cdot {D}_{t}}{{max}_{i} \vert {m}_{i} \vert} ,$$

mᵢ=[|wᵢ₁|², |wᵢ₂|², . . . |w_{id}|²], wᵢₛ denotes a vector formed by weights over the ith channel of a sth convolution kernel of the each of the first plurality of particular layers, s=1, 2, . . . , d.

In some embodiments, the device may further include a second updating unit configured to: before inputting the corrected computation result of the each of the first plurality of particular layers into the nonlinear layer corresponding to the each of the first plurality of particular layers of the neural network model, update the corrected computation result to be a first threshold if the corrected computation result is not greater than a first threshold, and update the corrected computation result to be a second threshold if the corrected computation result is greater than the second threshold, wherein the first threshold and the second threshold are determined based on parameters of the BN layer corresponding to the each of the first plurality of particular layers.

In some embodiments, the first threshold d and the second threshold u may be obtained based on following equations:

$$d = - k γ + β , u = k γ + β ,$$

wherein γ and β are the parameters of the BN layer corresponding to the each of the first plurality of particular layers, and k is a preset value.

In some embodiments, the applied IRP noise may cause a correlation between the computation result of the each of the third plurality of particular layers in the REE and an output of the non-linear layer corresponding to the each of the third plurality of particular layers to which the IRP noise has been applied to be less than a predetermined value.

In some embodiments, the IRP noise e applied to the output of the non-linear layer may be obtained based on following equation:

$$e = r + c ,$$

wherein respective elements of r are independent from each other and follow an identical distribution, and r is Gaussian white noise with a mean of 0 and a variance of not being less than Dₘᵢₙ, where

$${D}_{min} = ( \frac{1}{{ρ}_{x , y}^{2}} - 1 ) \cdot {( \frac{b - a}{2} )}^{2} ,$$

c denotes random samples on an interval [a,b], wherein ρ_{x,y} is a preconfigured Pearson's correlation coefficient, wherein a is obtained by mapping of the first threshold through a nonlinear layer and b is obtained by mapping of the second threshold through the nonlinear layer.

In some embodiments, τ that is a vector of the IRP noise correction factors corresponding to the each of the second plurality of particular layers may be obtained based on following equation:

τ=Conv(e, Ŵ),

wherein e denotes IRP noise applied to an output of a nonlinear layer corresponding to a previous particular layer of the each of the second plurality of particular layers, and Ŵ denotes weights of convolution kernels of the each of the second plurality of particular layers that have been perturbed.

According to some embodiments, a non-transitory computer readable storage medium may store a computer program that when executed by a processor causes the processor to implement the method for implementing inference of the neural network model as described above.

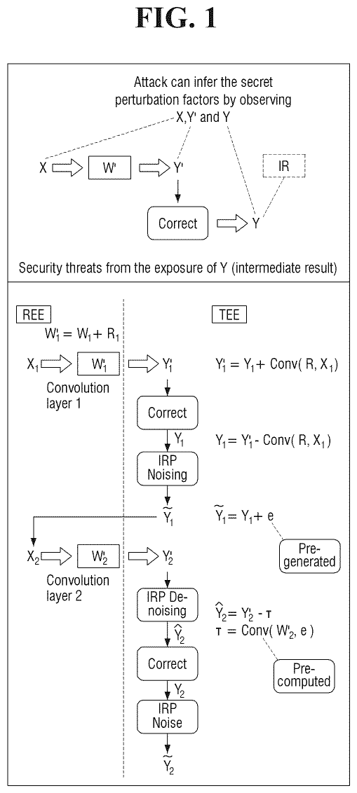

FIG. 1 illustrates a schematic diagram of an example of an inference computation for a convolution layer of a neural network model based on an additive perturbation.

Referring to FIG. 1, for a convolution layer 1, an additive perturbation R₁ is applied to convolution weights W₁ to obtain perturbed weights W′₁; Y′₁ is calculated based on the inputs X₁ of the convolution layer 1 and W′₁ in a REE; Y′₁ is corrected to obtain Y₁ (i.e., a computation result of the convolution layer 1 obtained based on X₁ and W₁ in the TEE); \tilde{Y}₁ is obtained by applying IRP noise e to Y₁, wherein \tilde{Y}₁ will be used as an input X₂ of a next convolution layer.

For a convolution layer 2, the additive perturbation R₂ is applied to convolution weights W₂ of the convolution layer to obtain the perturbed weights W′₂; Y′₂ is obtained based on X₂ and W′₂ in the REE; and an IRP de-noising process is firstly performed on Y′₂ in the TEE to obtain the de-noised [symbol] (i.e., Y′₂−τ, wherein τ=Conv(W′₂, e), and Y₂ is then obtained by correcting [symbol] based on the perturbation factors R₂.

As described above, for a convolution layer, perturbed weights W′ may be obtained by applying the additive perturbation R to weights W of the convolutional layer, and then Y′ may be computed in the REE based on the following equation (1):

$$\begin{matrix}{Y}^{′} = Conv ( {W}^{′} , X ) + B \\ = Conv ( W + R , X ) + B \\ = Conv ( W , X ) + B + C o n v ( R , X ) \\ = Y + Con v ( R , X )\end{matrix} , \qquad ( 1 )$$

wherein B denotes bias parameters of the convolution layer.

When Y′ is corrected to obtain Y in the TEE, Conv(R, X) needs to be computed. Thus, Conv(W′, X) needs to be computed in the REE and Conv(R, X) needs to be computed in the TEE. Since convolution of R and X has the same amount of computation as that of convolution of W′ and X, the computation of the convolutional layer based on the additive perturbation requires a large amount of computation.

Similarly, for a fully connected layer of the neural network model, the additive perturbation R may be applied to weights W of the fully connected layer, and Y′ may be computed based on the following equation (2) in the REE:

$$\begin{matrix}{Y}^{′} = {W}^{′} X + B \\ = ( W + R ) X + B \\ = Y + RX\end{matrix} . \qquad ( 2 )$$

Since RX needs to be computed in the TEE to obtain a corrected result, an amount of this computation is the same as that of computing WX, and thus the computation of the fully connected layer based on the additive perturbation also requires a large amount of computation.

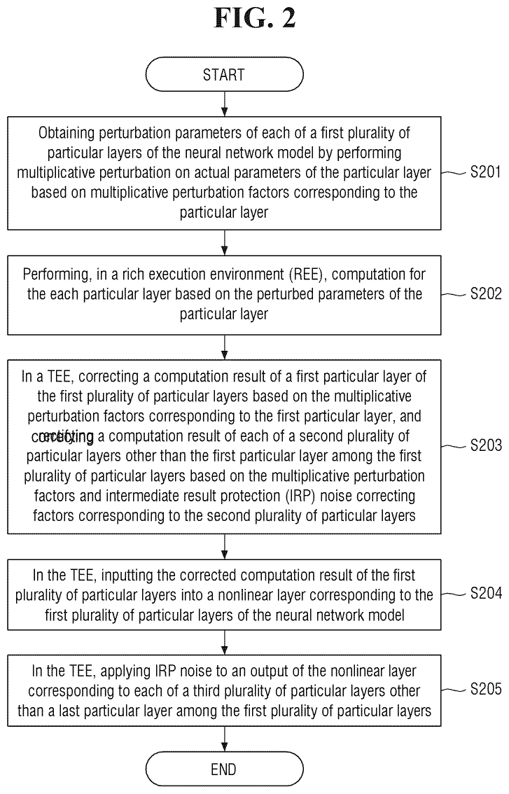

FIG. 2 illustrates a flowchart of a method for implementing inference of a neural network model according to some embodiments.

Referring to FIG. 2, at operation S201, perturbation parameters of each of a first plurality of particular layers of the neural network model are obtained by performing multiplicative perturbation on actual parameters of the particular layer based on multiplicative perturbation factors corresponding to the particular layer, wherein the each particular layer is a convolution layer or a fully connected layer.

Although FIG. 2 shows the method for implementing inference of a neural network model as including operations S201-S205. This is only an example and, in some embodiments, operation S201 may be omitted. In some embodiments, operation S201 may be performed by a model perturbation apparatus in a factory as a production tool to turn a trained model into a perturbed model. In some embodiments, operation S202 to operation S205 may be performed by a secure inference apparatus that is deployed in products and executes an inference using the perturbed model.

At operation S202, computation for each particular layer based on the perturbed parameters of the particular layer is performed, in a rich execution environment (REE).

Since the perturbed parameters are used in the REE, data of the model may be protected.

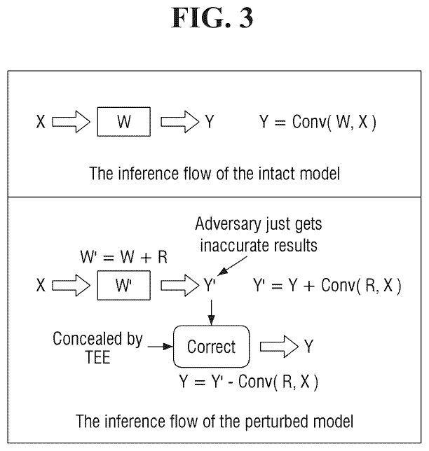

FIG. 3 illustrates a schematic diagram of an example of performing multiplicative perturbation on a particular layer of a neural network model based on multiplicative perturbation factors, according to some embodiments.

Referring to FIG. 3, perturbed weights AW may be obtained by performing multiplicative perturbation on weights W of a particular layer based on a multiplicative perturbation factor λ, so that when correcting Y′ (i.e., λY, wherein Y is a computation result based on the input X of the particular layer and the actual weights W of the particular layer) in the TEE, the corrected computation result may be obtained by simply dividing Y′ by the multiplicative perturbation factor λ, and the amount of this computation is much less than that of the additive perturbation-based inference as described above.

Since the overhead for perturbation and correction is effectively controlled, the present disclosure may implement perturbations on parameters of all convolution layers and all fully connected layers in the model without deterioration of performance, thereby addressing the problem that security has to be sacrificed and part of the weights have to be leaked in order to improve computation performance in the related art.

As an example, the obtaining of the perturbed parameters of each particular layer may include determining a vector λ=[λ₁, λ₂, . . . , λ_{d}] of the perturbation factors corresponding to convolution kernels of the each of the first plurality of particular layers, wherein respective perturbation factors in the vector of the perturbation factors follow a distribution defined by following equations (3) and (4):

$$E [ {λ}_{s} ] = 0 , \qquad ( 3 )$$

$$Var [ {λ}_{s} ] = \frac{{G}^{2} \cdot {D}_{t}}{{max}_{i} {\vert {w}_{i} \vert}^{2}} , \qquad ( 4 )$$

wherein d denotes a number of the convolution kernels of the first plurality of particular layers, E[λₛ] and Var[λₛ] denote a mean and a variance of the sth perturbation factor in the vector of the perturbation factors, respectively, G denotes an activation function gain value, Dₜ denotes an expected attenuation of a gradient variance as it propagates backward in the each of the first plurality of particular layers, and wᵢ denotes a vector formed by weights over channels of the ith convolution kernel in W, W denotes a weight matrix for all convolution kernels of the first plurality of particular layers, s=1, 2, . . . , d.

The obtaining may further include obtaining perturbed weights and perturbed biases of the convolution kernels of the first plurality of particular layers by performing multiplicative perturbation on actual weights and actual biases of the convolution kernels of the first plurality of particular layers based on the vector of the perturbation factors corresponding to the convolution kernels of the first plurality of particular layers.

A correlation between the computation result of the convolution kernel of the model perturbed based on the perturbation factors defined based on the equations (3) and (4) and a real computation result of the convolution kernel of the mode that is not perturbed during forward propagation of the model is zero, that is, the two computation results are linearly independent. This linear independence means that the perturbation plays a sufficient role so that an attacker may be prevented from intercepting the data of the model based on a relationship between the perturbed computation result and the real computation result.

As an example, if it is assumed that the convolution layer 1 has d convolution kernels and the vector of the perturbation factors of the convolution layer lis λ=[λ₁, λ₂, . . . , λ_{d}], the actual weight Wₛ and the actual perturbation bias Bₛ of the sth convolution kernel are perturbed based on the following equations (5) and (6) to obtain the perturbed weight Ŵₛ and the perturbed bias \hat{B}ₛ, respectively:

$${\hat{W}}_{s} = {W}_{s} \cdot {λ}_{s} , \qquad ( 5 )$$

$${\hat{B}}_{s} = {B}_{s} \cdot {λ}_{s} . \qquad ( 6 )$$

As an example, the obtaining of the perturbation parameters of the particular layer may further include, when the each of the first plurality of particular layers is a convolution layer, before obtaining the perturbed weights and the perturbed biases of the convolution kernels of the first plurality of particular layers by performing the multiplicative perturbation on the actual weights and the actual biases of the convolution kernels of the first plurality of particular layers based on the vector of the perturbation factors corresponding to the convolution kernels of the first plurality of particular layers, updating the actual weights and the actual biases of the convolution kernels of the first plurality of particular layers based on the actual parameters of the first plurality of particular layers and parameters of a batch normalization (BN) layer corresponding to the first plurality of particular layers of the neural network model; and deleting the BN layer or initializing the parameters of the BN layer.

As an example, the updating of the actual weights and the actual biases of the convolution kernels of the first plurality of particular layers may include obtaining the updated weights \tilde{W} and the updated biases \tilde{B} of the convolution kernels of the first plurality of particular layers based on following equations:

$$\tilde{W} = \frac{γ W}{\sqrt{{σ}^{2} + ϵ}} , \qquad ( 7 )$$

$$\tilde{B} = β J + γ \frac{B - μ J}{\sqrt{{σ}^{2} + ϵ}} , \qquad ( 8 )$$

wherein W and B denote the actual weights and the actual biases of the convolution kernels of the first plurality of particular layers respectively, γ, β, μ, σ and ϵ are parameters of the BN layer, and J denotes an all-ones matrix (i.e., a matrix in which each element is one).

As an example, although the parameters of the BN layer are initialized, the original parameters γ and β of the BN layer need to be backed up to be used for subsequent calculations.

As an example, the initialized values of the parameters γ, β, μ, and σ of the BN layer may be 1, 0, 0, and 1, respectively.

As an example, the obtaining of the perturbed weights and the perturbed biases of the convolution kernels of the first plurality of particular layers by performing the multiplicative perturbation on the actual weights and the actual biases of the convolution kernels of the first plurality of particular layers based on the vector of the perturbation factors corresponding to the convolution kernels of the first plurality of particular layers includes obtaining the perturbed weights and the perturbed biases the convolution kernels of the first plurality of particular layers by performing the multiplicative perturbation on the updated actual weights and the updated actual biases of the convolution kernels of the first plurality of particular layers based on the vector of the perturbation factors corresponding to the convolution kernels of the first plurality of particular layers.

The parameters of the BN layer reflect statistical properties of an output of the corresponding convolution kernel and are helpful for the attacker to explore the model in reverse, so fusing parameters of the two layers firstly before perturbing the model, and initializing original parameters of the BN layer at the same time may both conceal the actual parameters of the BN layer, and force the attacker to start from a fully initialized state when re-training the BN layer.

As an example, the perturbed weights Ŵₛ and the perturbed bias \hat{B}ₛ may be obtained by performing multiplicative perturbation on the updated actual weights \tilde{W}ₛ and the updated actual biases \tilde{B}ₛ of the convolution kernel of the convolution layer based on the following equations (9) and (10):

$${\hat{W}}_{s} = {\tilde{W}}_{s} \cdot {λ}_{s} , \qquad ( 9 )$$

$${\hat{B}}_{s} = {\tilde{B}}_{s} \cdot {λ}_{s} . \qquad ( 10 )$$

As an example, the method shown in FIG. 2 may further include calculating |ξ| that is a modulus of a vector ξ formed by squares of perturbation factors in the vector of the perturbation factors corresponding to the convolution kernels of the first plurality of particular layers; and updating the vector of the perturbation factors corresponding to the convolution kernels of the first plurality of particular layers to be

$$λ \cdot \sqrt{\frac{M}{\vert ξ \vert}}$$

when |ξ| is greater than M, wherein

$$M = \frac{{G}^{2} \cdot {D}_{t}}{{max}_{i} \vert {m}_{i} \vert} ,$$

mᵢ=[|wᵢ₁|², |wᵢ₂|², . . . |w_{id}|²], wᵢₛ denotes a vector formed by weights over the ith channel of the sth convolution kernel of the first plurality of particular layers, s=1, 2, . . . , d.

According to some embodiments, the model perturbed based on the updated perturbation factors facilitates layer-by-layer decay of the variance of the gradient during back propagation. This facilitation of the layer-by-layer decay prevents a shallow network from getting rich gradient updates when the attacker performs training based on the perturbed model, thereby reducing expressiveness of the model.

Returning to FIG. 2, at operation S203, a first computation result of a first particular layer of the first plurality of particular layers is corrected based on the multiplicative perturbation factors corresponding to the first particular layer, and a second computation result of each of a second plurality of particular layers other than the first particular layer among the first plurality of particular layers is corrected based on the multiplicative perturbation factors and intermediate result protection (IRP) noise correction factors corresponding to the second plurality of particular layers, in a trusted execution environment (TEE).

Since IRP noise is not applied to the input of the first particular layer when performing calculations based on the input of the first particular layer and the perturbed parameters of the first particular layer, there is no need to perform elimination of the IRP noise before correcting the computation result in the REE of the first particular layer in the TEE, and thus it is only needed to correct the computation results of the first particular layer in the REE based on the multiplicative perturbation factors corresponding to the particular layer.

It should be appreciated by those skilled in the art that the computation result of the perturbed convolution kernel must be corrected to be a true value before it is allowed to be inputted into a non-linear layer (e.g., an activation function). This need for correction is because the computation result based on the perturbation cannot be corrected after being nonlinearly transformed.

As an example, if it is assumed that an output of the dth convolution kernel of the lth convolution layer is ŷₗ, then the corrected result yₗ of ŷₗ may be obtained based on the following equation (11):

$${y}_{l} = \frac{1}{{λ}_{d}} ( {\hat{y}}_{l} - {τ}_{l} ) , \qquad ( 11 )$$

wherein λ_{d} is a perturbation factor of the dth convolution kernel, τₗ denotes an IRP noise correction factor corresponding to the dth convolution kernel, and is a vector with a dimension equal to a dimension of an output vector of the dth convolution kernel. τₗ is computed in advance before the inference starts and is stored in a secure cache. τₗ does not need to be computed when the correction is performed on ŷₗ, and may be read from the secure cache and used directly, and the computation for τₗ will be described later.

At operation S204, the corrected first computation result of the first plurality of particular layers is input into a nonlinear layer corresponding to the first plurality of particular layers of the neural network model in the TEE.

As an example, the non-linear layers may include an activation layer, a pooling layer, etc. The non-linear layers are not affected by the perturbations and have the same computing way as that in the original model. For example, for an activation function f corresponding to the lth convolution layer, the output xₗ₊₁ of the activation function f may be expressed as:

$${x}_{l + 1} = f ( {y}_{l} ) , \qquad ( 12 )$$

wherein xₗ₊₁ will be used as the input of the l+1th convolution layer.

At operation S205, IRP noise is applied to an output of the nonlinear layer corresponding to each of a third plurality of particular layers other than a last particular layer among the first plurality of particular layers.

As described above, in some embodiment, only operation S202 to operation S205 may be performed by a secure inference apparatus that is deployed in products and executes inference using the perturbed model.

Since the present disclosure is based on multiplicative perturbation, if the true output of the convolution kernel is exposed, an attacker may directly calculate the perturbation factor by comparing the data before and after the correction, and then intercept the parameters of the model. Therefore, intermediate results need to be protected, that is, the data that is corrected and activated in the TEE cannot be directly passed to the REE, but concealed by applied noise.

As an example, τ that is a vector of the IRP noise correction factors corresponding to the each of the second plurality of particular layers is obtained based on following equation:

τ=Conv(e, Ŵ),

wherein e denotes IRP noise applied to an output of a nonlinear layer corresponding to a previous particular layer of the each of the second plurality of particular layers, and Ŵ denotes weights of convolution kernels of the each of the second plurality of particular layers that have been perturbed.

As an example, it is assumed that xₗ is a computation result by performing correction and activation on computation result of a convolution layer l−1, and \hat{x}ₗ=xₗ+eₗ is obtained by applying IRP noise eₗ to xₗ. The \hat{x}ₗ is the input of the convolution layer l, and a convolution result ŷₗ corresponding to \hat{x}ₗ may be obtained based on an equation (13):

$$\begin{matrix}{\hat{y}}_{l} = C o n v ( {\hat{x}}_{l} , {\hat{W}}_{l} ) + {\hat{B}}_{l} = C o n v ( {x}_{l} + {e}_{l} , {\hat{W}}_{l} ) + {\hat{B}}_{l} \\ = Con v ( {x}_{l} , {\hat{W}}_{l} ) + {\hat{B}}_{l} + C o n v ( {e}_{l} , {\hat{W}}_{l} ) = λ {y}_{l} + C o n v ( {e}_{l} , {\hat{W}}_{l} )\end{matrix} , \qquad ( 13 )$$

wherein Ŵₗ and \hat{B}ₗ are the perturbed weights and the perturbed biases of the convolution layer l respectively, and λ is a perturbation factor corresponding to the convolution layer l.

As an example, the IRP noise correction factors (or a vector of IRP noise correction factors) τₗ corresponding to convolution layer 1 may be obtained based on the equation (14):

$${τ}_{l} = C o n v ( {e}_{l} , {\hat{W}}_{l} ) . \qquad ( 14 )$$

It should be appreciated by those skilled in the art that the IRP noise eₗ and the IRP correction factors τₗ in the present disclosure are computed in advance prior to inference and are stored in a secure cache, and the IRP noise eₗ and the IRP correction factors τₗ may be read from the secure cache directly and used when eliminating the IRP noise.

As an example, the method shown in FIG. 2 may further include, before the inputting of the corrected first computation result of the first plurality of particular layers into the nonlinear layer of the neural network model, updating the corrected computation result to be a first threshold if the corrected computation result is not greater than a first threshold, and updating the corrected computation result to be a second threshold if the corrected computation result is greater than the second threshold, wherein the first threshold and the second threshold are determined based on parameters of the BN layer corresponding to the each of the first plurality of particular layers.

The attacker may input an arbitrary signal into the particular layer in the REE, and if the attacker inputs a signal with a sufficiently large amplitude, the role of the IRP noise may be weaken and the perturbation factor may be leaked.

For example, the input \hat{x}ₗ₊₁ of the convolution layer l+1 is obtained by performing correction, computation in the nonlinear layer and applying IRP noise on a value outputted from the convolution layer l in the REE. If only linear portion of the activation function is considered, \hat{x}ₗ₊₁ may be expressed as follows:

$${\hat{x}}_{l + 1} = \frac{1}{λ} ( {\hat{y}}_{l} - {τ}_{l} ) + {e}_{l + 1} . \qquad ( 15 )$$

The attacker may compute the ratio of the input \hat{x}ₗ₊₁ of the convolution layer l+1 in the REE to the output ŷₗ of convolution layer l in the REE as follows:

$$\frac{{\hat{x}}_{l + 1}}{{\hat{y}}_{l}} = \frac{{\hat{y}}_{l} + λ {e}_{l + 1} - {τ}_{l}}{λ {\hat{y}}_{l}} = \frac{1}{λ} + \frac{{e}_{l + 1}}{{\hat{y}}_{l}} - \frac{{τ}_{l}}{λ {\hat{y}}_{1}} .$$

When the attacker inputs a signal with a sufficiently large value, for example, when ŷₗ>>eₗ₊₁ and ŷₗ>>τₗ,

$$\frac{{\hat{x}}_{l + 1}}{{\hat{y}}_{l}} ⟶ \frac{1}{λ} ,$$

which results in leaking of the perturbation factor λ.

This threat may be avoided if amplitude of the input signal may be limited so that a stable and sufficiently low signal-to-noise ratio is maintained between ŷₗ and the IRP noise.

Since the parameters of the BN layer corresponding to the particular layer reflect statistical characteristics of output signals of respective convolution kernels, a limiting interval for the input signal may be determined based on the parameters of the BN layer.

In an ideal case, a mean value of output signals of the convolution kernel is close to the parameter β of the corresponding BN layer, and a standard deviation of the output signals of the convolution kernel is close to the parameter γ of the corresponding BN layer, and according to Chebyshev's inequality, the probability that values of the output signals of the convolution kernel fall in an interval of (−kγ+β, kγ+β) is not below

$$1 - \frac{1}{{k}^{2}} ,$$

wherein k∈N₊. The interval may therefore be determined by choosing an appropriate value of k. The value of k being too small may result in that normal inputs are filtered, which affects inference accuracy, while the value of k being too large allows the attacker to input a signal with a large amplitude, which requires a large variance of the IRP noise, and may lead to computation saturation in subsequent convolution layers.

As an example, the first threshold d and the second threshold u are obtained based on following equations (16) and (17):

$$d = - k γ + β , \qquad ( 16 )$$

$$u = k γ + β , \qquad ( 17 )$$

wherein γ and β are the parameters of the BN layer corresponding to the each of the first plurality of particular layers, and k is a preset value.

As an example, k may be adjusted to be as small as possible without compromising the accuracy of the model with a test dataset during a production phase. For example, for the ImageNet pre-trained Darknet-19 model (with 1000 classes), when k=8, the accuracy of the model is acc1=72.17% and acc5=90.55% which are almost the same as the original accuracy of the model (acc1=72.23% and acc5=90.62%).

Once k is determined, limiting intervals corresponding to respective convolution kernels may be computed based on parameters of BN layers corresponding to respective convolution kernels, wherein d and u are the lower bound and upper bound of the limiting interval corresponding to a convolution kernel, respectively, and d and u are computed at the production stage and built into the TEE of the product.

As an example, if it is assumed that the corrected signal is x and the limiting interval is [d, u] calculated at the production stage, an output y corresponding to x is obtained based on the following equation:

$$y = \{ \begin{matrix}d & x \leq d \\ x & d < x \leq u \\ u & x > u\end{matrix} . \qquad ( 18 )$$

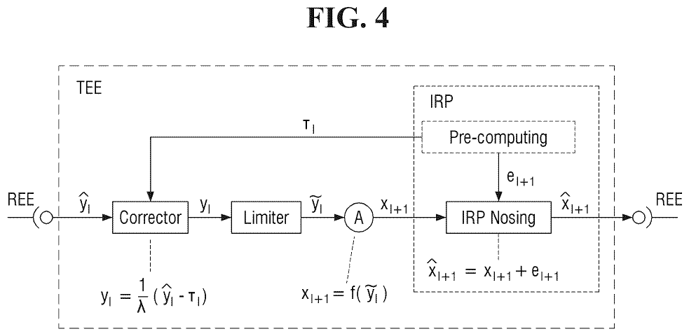

FIG. 4 illustrates a schematic diagram of a process of performing correcting, limiting, non-linear computing, and applying of IRP noise on a computation result in the REE of the Ith particular layer in a TEE according to some embodiments.

Referring to FIG. 4, the computational result ŷₗ in the REE is corrected to be yₗ based on multiplicative factors and an IRP noise correction factor τₗ by for example a rectifier, \tilde{y}ₗ is obtained by limiting the amplitude of yₗ by for example a limiter, xₗ₊₁ is obtained by performing computation on \tilde{y}ₗ in the nonlinear layer (e.g., an activation function A), and \hat{x}ₗ₊₁ is obtained as an input of a next particular layer l+1 by applying IRP noise eₗ₊₁ to xₗ₊₁, wherein τₗ and eₗ₊₁ are pre-computed at the production phase.

As an example, the applied IRP noise causes a correlation between the computation result of the each of the third plurality of particular layers in the REE and an output of the non-linear layer corresponding to the each of the third plurality of particular layers to which the IRP noise has been applied to be less than a predetermined value.

For example, if it is assumed that there exists a linear regression equation \hat{x}ₗ₊₁=aŷₗ+b, and data are distributed in linear interval for the activation function, then its regression coefficient

$$a = \frac{1}{λ}$$

may be calculated. As can be seen, the perturbation factor may be obtained if the attacker has trained a linear regression model.

In order to prevent the attacker from obtaining the exact perturbation factor, it is necessary to make sure that xₗ₊₁ is weakly correlated with ŷₗ, which may be achieved by applying suitable IRP noise. For example, by making the correlation between \hat{x}ₗ₊₁ and ŷₗ to be less than a set threshold, the attacker may be prevented from obtaining the exact perturbation factor.

As an example, the IRP noise e applied to the output of the non-linear layer is obtained based on following equation:

$$e = r + c ,$$

wherein respective elements of r are independent from each other and follow an identical distribution, and r is Gaussian white noise with a mean of 0 and a variance of not being less than Dₘᵢₙ,

$${D}_{min} = ( \frac{1}{{ρ}_{x , y}^{2}} - 1 ) \cdot {( \frac{b - a}{2} )}^{2} ,$$

c denotes random samples on an interval [a,b], wherein ρ_{x,y} is a preconfigured Pearson's correlation coefficient, wherein a is obtained by mapping of the first threshold through a nonlinear layer and b is obtained by mapping of the second threshold through the nonlinear layer.

Specifically, a set S may be defined as follows:

S={x∈ [symbol] :x∈[d, u]},

wherein [d, u] may be determined based on the equations (16) and (17).

Since the IRP noise is for activated signals, [d, u] needs to be mapped to a new interval through the activation function. If it is assumed that the activation function is f, the set S may be mapped to a set T through f as follows:

f:S→T,

wherein T={y∈ [symbol] :y∈[a, b]}.

As an example, a variance Var[eᵢ] of the IRP noise e should satisfy the following equation:

$$Var [ {e}_{i} ] \geq ( \frac{1}{{ρ}_{x , y}^{2}} - 1 ) \cdot {( \frac{b - a}{2} )}^{2} = {D}_{min} ,$$

wherein i=1, 2, . . . N, N indicates the number of elements in e, ρ_{x,y} is a configurable parameter, and the closer ρ_{x,y} is to 0, the lower a correlation is. Typically, ρ_{x,y} may be configured to be 0.02.

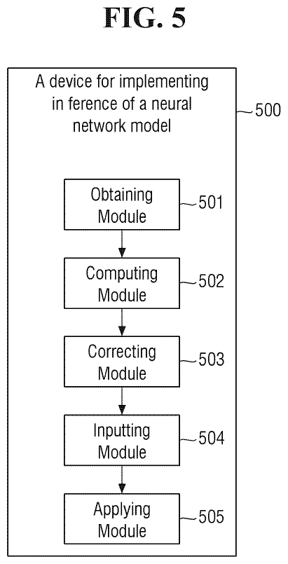

The method for implementing inference of a neural network model according to some embodiments are described above with reference to FIGS. 1 to 4, and a device for implementing inference of a neural network model and a computer readable storage medium according to some embodiments are described below with reference to FIG. 5.

FIG. 5 illustrates a block diagram of a structure of a device for implementing inference of a neural network model 500 according to some embodiments.

Referring to FIG. 5, the device for implementing inference of a neural network model 500 may include at least one memory storing computer program code and at least one processor that accesses the memory to execute the computer program code to cause the at least one processor to implement an obtaining module 501, a computing module 502, a correcting module 503, an inputting module 504 and an applying module 505. It should be understood by those skilled in the art that the device for implementing inference of a neural network model 500 may additionally include other components, and that at least one of components included in the device for implementing inference of a neural network model 500 may be combined or divided.

In some embodiments, the device 500 may omit the obtaining module 501. In some embodiments, the device 500 may include only the obtaining module 501. In some embodiments, a first device may include only the obtaining module 501, and a second device that is separate from the first device may include the computing module 502, the correcting module 503, the inputting module 504 and the applying module 505.

As an example, the obtaining module 501 may be configured to obtain perturbation parameters of each of a first plurality of particular layers of the neural network model by performing multiplicative perturbation on actual parameters of the particular layer based on multiplicative perturbation factors corresponding to the particular layer, wherein the each particular layer is a convolution layer or a fully connected layer.

As an example, the computing module 502 may be configured to perform, in a rich execution environment (REE), computation for each particular layer based on the perturbed parameters of the particular layer. As discussed above, in some embodiments, the second device may include the computing module 502, the correcting module 503, the inputting module 504, and the applying module 505. In some embodiments, the second device may include at least one first memory may be configured to store computer code for implementing the computing module 502 and at least one first processor that accesses the at least one first memory to execute the first computer code in order to implement the computing module 502. In some embodiments, the at least one first memory and the at least one first processor may be included in a rich execution environment (REE). For example, the REE may execute a operating system of a device and may not be secure from attackers.

As an example, the correcting module 503 may be configured to, in a trusted execution environment (TEE), correct a first computation result of a first particular layer of the first plurality of particular layers based on the multiplicative perturbation factors corresponding to the first particular layer, and correct a second computation result of each of a second plurality of particular layers other than the first particular layer among the first plurality of particular layers, based on the multiplicative perturbation factors and intermediate result protection (IRP) noise correction factors corresponding to the second plurality of particular layers.

As an example, the inputting module 504 may be configured to, in the TEE, input the corrected computation result of the first plurality of particular layers into a nonlinear layer corresponding to the first plurality of particular layers of the neural network model.

As an example, the applying module 505 may be configured to, in the TEE, apply IRP noise to an output of the nonlinear layer corresponding to each of a third plurality of particular layers other than a last particular layer among the first plurality of particular layers,

As an example, the IRP noise correction factors corresponding to the second plurality of particular layers may be determined based on IRP noise applied to an output of a nonlinear layer corresponding to a previous particular layer of the second plurality of particular layers, the output of the non-linear layer corresponding to the each of the third plurality of particular layers to which the IRP noise has been applied is an input to a next particular layer of the third plurality of particular layers, and an output of the last nonlinear layer of the neural network model is an inference result of the neural network model.

As discussed above in some embodiments, the second device may include the computing module 502, the correcting module 503, the inputting module 504, and the applying module 505. In some embodiments, the second device may include at least one second memory configured to store second computer code for implementing the correcting module 503, the inputting module 504, and the applying module 505, and at least one second processor that accesses the at least one second memory to execute the second computer code in order to implement the correcting module 503, the inputting module 504, and the applying module 505. In some embodiments, the at least one second memory and the at least one second processor may be included in a trusted execution environment (TEE) which isolate the running code and data from an attacker. For example, the TEE may isolate the second computer code running on the at least one second processor from the REE and from attackers.

As an example, the obtaining module 501 may be configured to determine a vector λ=[λ₁, λ₂, . . . , λ_{d}] of the perturbation factors corresponding to convolution kernels of the first plurality of particular layers, wherein respective perturbation factors in the vector of the perturbation factors follow a distribution defined by following equations:

$$\begin{matrix}E [ {λ}_{s} ] = 0 , \\ Var [ {λ}_{s} ] = \frac{{G}^{2} \cdot {D}_{t}}{{max}_{i} {\vert {w}_{i} \vert}^{2}} ,\end{matrix}$$

wherein d denotes a number of the convolution kernels of the first plurality of particular layers, E[λₛ] and Var[λₛ] denote a mean and a variance of the sth perturbation factor in the vector of the perturbation factors, respectively, G denotes an activation function gain value, Dₜ denotes an expected attenuation of a gradient variance as the gradient variance propagates backward in the first plurality of particular layers, and wᵢ denotes a vector formed by weights over channels of the ith convolution kernel in W, W denotes a weight matrix for all convolution kernels of the first plurality of particular layers, s=1, 2, . . . , d; and obtain perturbed weights and perturbed biases of the convolution kernels of the first plurality of particular layers by performing multiplicative perturbation on actual weights and actual biases of the convolution kernels of the first plurality of particular layers based on the vector of the perturbation factors corresponding to the convolution kernels of the first plurality of particular layers.

As an example, the obtaining module 501 may be further configured to, when the first plurality of particular layers is a convolution layer, before obtaining the perturbed weights and the perturbed biases of the convolution kernels of the first plurality of particular layers by performing the multiplicative perturbation on the actual weights and the actual biases of the convolution kernels of the first plurality of particular layers based on the vector of the perturbation factors corresponding to the convolution kernels of the first plurality of particular layers, update the actual weights and the actual biases of the convolution kernels of the first plurality of particular layers based on the actual parameters of the first plurality of particular layers and parameters of a batch normalization (BN) layer corresponding to the first plurality of particular layers of the neural network model, and delete the BN layer or initializing the parameters of the BN layer.

As an example, the obtaining module 501 may be configured to obtain the perturbed weights and the perturbed biases the convolution kernels of the first plurality of particular layers by performing the multiplicative perturbation on the updated actual weights and the updated actual biases of the convolution kernels of the first plurality of particular layers based on the vector of the perturbation factors corresponding to the convolution kernels of the first plurality of particular layers.

As an example, the obtaining module 501 may be configured to obtain the updated weights \tilde{W} and the updated biases \tilde{B} of the convolution kernels of the first plurality of particular layers based on following equations:

$$\tilde{W} = \frac{γ W}{\sqrt{{σ}^{2} + ϵ}} , \tilde{B} = β J + γ \frac{B - μ J}{\sqrt{{σ}^{2} + ϵ}} ,$$

wherein W and B denote the actual weights and the actual biases of the convolution kernels of the first plurality of particular layers respectively, γ, β, μ, σ and ϵ are parameters of the BN layer, and J denotes an all-ones matrix.

As an example, the device for implementing inference of a neural network model 500 may further include a first updating module (not shown).

As an example, the first updating module may be configured to calculate |ξ| that is a modulus of a vector ξ formed by squares of perturbation factors in the vector of the perturbation factors corresponding to the convolution kernels of the first plurality of particular layers, and update the vector of the perturbation factors corresponding to the convolution kernels of the first plurality of particular layers to be

$$λ \cdot \sqrt{\frac{M}{\vert ξ \vert}}$$

when |ξ| is greater than M,
wherein

$$M = \frac{{G}^{2} \cdot {D}_{t}}{{max}_{i} \vert {m}_{i} \vert} ,$$

mᵢ=[|wᵢ₁|², |wᵢ₂|², . . . |w_{id}|²], wᵢₛ denotes a vector formed by weights over the ith channel of the sth convolution kernel of the first plurality of particular layers, s=1, 2, . . . , d.

As an example, the device for implementing inference of a neural network model 500 may further include a second updating module (not shown).

As an example, the second updating module may be configured to, before inputting the corrected computation result of the first plurality of particular layers into the nonlinear layer corresponding to the first plurality of particular layers of the neural network model, update the corrected computation result to be a first threshold if the corrected computation result is not greater than a first threshold, and update the corrected computation result to be a second threshold if the corrected computation result is greater than the second threshold, wherein the first threshold and the second threshold are determined based on parameters of the BN layer corresponding to the first plurality of particular layers.

As an example, the first threshold d and the second threshold u are obtained based on following equations: d=−kγ+β, u=kγ+β, wherein γ and β are the parameters of the BN layer corresponding to the first plurality of particular layers, and k is a preset value.

As an example, the applied IRP noise causes a correlation between the computation result of the third plurality of particular layers in the REE and an output of the non-linear layer corresponding to the third plurality of particular layers to which the IRP noise has been applied to be less than a predetermined value.

As an example, the IRP noise e applied to the output of the non-linear layer is obtained based on following equation: e=r+c, wherein respective elements of r are independent from each other and follow an identical distribution, and r is Gaussian white noise with a mean of 0 and a variance of not being less than Dₘᵢₙ,

$${D}_{min} = ( \frac{1}{{ρ}_{x , y}^{2}} - 1 ) \cdot {( \frac{b - a}{2} )}^{2} ,$$

c denotes random samples on an interval [a, b], wherein ρ_{x,y} is a preconfigured Pearson's correlation coefficient, wherein a is obtained by mapping of the first threshold through a nonlinear layer and b is obtained by mapping of the second threshold through the nonlinear layer.

As an example, τ that is a vector of the IRP noise correction factors corresponding to the second plurality of particular layers is obtained based on following equation:
τ=Conv(e, Ŵ), wherein e denotes IRP noise applied to an output of a nonlinear layer corresponding to a previous particular layer of the second plurality of particular layers, and Ŵ denotes weights of convolution kernels of the second plurality of particular layers that have been perturbed.

According to some exemplary embodiments, there is provided a non-transitory computer readable storage medium storing a computer program that when executed by a processor causes the processor to implement the method of implementing inference for a neural network model as described above. Examples of computer-readable storage media here include: read only memory (ROM), random access programmable read only memory (PROM), electrically erasable programmable read only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, hard disk drive (HDD), solid state Hard disk (SSD), card storage (such as multimedia card, secure digital (SD) card or extreme digital (XD) card), magnetic tape, floppy disk, magneto-optical data storage device, optical data storage device, hard disk, solid state disk and any other devices configured to store computer programs and any associated data, data files, and data structures in a non-transitory manner, and provide the computer programs and any associated data, data files, and data structures to the processor or the computer, so that the processor or the computer can execute the computer program. The computer program in the above-mentioned computer-readable storage medium may run in an environment deployed in computing equipment such as a client, a host, an agent device, a server, etc. In addition, in one example, the computer program and any associated data, data files and data structures are distributed on networked computer systems, so that computer programs and any associated data, data files, and data structures are stored, accessed, and executed in a distributed manner through one or more processors or computers.

According to some embodiments, there may be provided a computer program product, wherein instructions in the computer program product may be executed by a processor of a computer device to implement the method for implementing inference of a neural network model described above.

Those skilled in the art will easily think of other embodiments after considering the specification and practicing the disclosure disclosed herein. The present disclosure is intended to cover any variations, uses, or adaptive changes of the present disclosure. These variations, uses, or adaptive changes follow the general principles of the present disclosure and include common knowledge or conventional technical means in the technical field that are not disclosed in the present disclosure. The specification and the embodiments are to be regarded as exemplary only, and the actual scope and spirit of the present disclosure are included in the following claims.

1. A method for implementing inference of a neural network model, the method comprising:
performing, in a rich execution environment (REE), computation for each of a plurality of convolution layers of the neural network model, based on multiplicative perturbation factors of the convolution layer and outputting a computation result of each of the plurality of convolution layers to a trusted execution environment (TEE); and
in the trusted execution environment (TEE):
correcting the computation result of a first convolution layer of the plurality of convolution layers based on the multiplicative perturbation factors corresponding to the first convolution layer,
correcting the computation result of each of remaining convolution layers other than the first convolution layer among the plurality of convolution layers based on the multiplicative perturbation factors and intermediate result protection (IRP) noise correction factors corresponding to the remaining convolution layers,
inputting the corrected computation result of the plurality of convolution layers into corresponding nonlinear layers of the neural network model, and
applying IRP noise to an output of the nonlinear layer corresponding to each of the plurality of convolution layers other than a last convolution layer among the plurality of convolution layers, and outputting the nonlinear layer to which the IRP noise has been applied to the REE,
wherein the IRP noise correction factors are based on IRP noise applied to the output of the nonlinear layer corresponding to a previous convolution layer of the remaining convolution layers, and
wherein an output of a last nonlinear layer of the neural network model is an inference result of the neural network model.

2. The method of claim 1, wherein the multiplicative perturbation factors of each of the plurality of convolution layers are obtained by:
determining a vector λ=[λ₁, λ₂, . . . , λ_{d}] of the multiplicative perturbation factors corresponding to convolution kernels of the plurality of convolution layers, the multiplicative perturbation factors in the vector λ having a distribution defined by:
$$E [ {λ}_{s} ] = 0 ,$$
$$Var [ {λ}_{s} ] = \frac{{G}^{2} \cdot {D}_{t}}{{max}_{i} {\vert {w}_{i} \vert}^{2}} ,$$
wherein d denotes a number of the convolution kernels of the plurality of convolution layers, E[λₛ] and Var[λₛ] denote a mean and a variance, respectively, of an sth multiplicative perturbation factor in the vector λ, G denotes an activation function gain value, Dₜ denotes an expected attenuation of a gradient variance as the gradient variance propagates backward in the plurality of convolution layers, and wᵢ denotes a vector formed by weights over channels of an ith convolution kernel in W, and W denotes a weight matrix for all convolution kernels of the plurality of convolution layers, s=1, 2, . . . , d; and
obtaining perturbed weights and perturbed biases of the convolution kernels of the plurality of convolution layers by performing multiplicative perturbation on actual weights and actual biases of the convolution kernels based on the vector λ.

3. The method of claim 2, wherein before obtaining the perturbed weights and the perturbed biases, updating the actual weights and the actual biases of the convolution kernels based on actual parameters of the plurality of convolution layers and parameters of a batch normalization (BN) layer corresponding to the plurality of convolution layers of the neural network model; and
deleting the BN layer or initializing the parameters of the BN layer, and
wherein the perturbed weights and the perturbed biases are obtains based on the actual weights and the actual biases that have been updated.

4. The method of claim 3, wherein the actual weights and the actual biases are updated the updated weights and the updated biases are based on the following equations:
$$\tilde{W} = \frac{γ W}{\sqrt{{σ}^{2} + ϵ}} , \tilde{B} = β J + γ \frac{B - μ J}{\sqrt{{σ}^{2} + ϵ}} ,$$
wherein \tilde{W} denotes the updated weights, \tilde{B} denotes the updated biases, W and B denote the actual weights and the actual biases, respectively, of the convolution kernels, γ, β, μ, σ and ϵ are the parameters of the BN layer, and J denotes an all-ones matrix.

5. The method of claim 2, further comprising:
calculating a modulus |ξ| of a vector ξ formed by squares of the multiplicative perturbation factors in the vector λ; and
updating the vector λ to be
$$λ \cdot \sqrt{\frac{M}{\vert ξ \vert}}$$
when |ξ| is greater than M, wherein
$$M = \frac{{G}^{2} \cdot {D}_{t}}{{max}_{i} \vert {m}_{i} \vert} ,$$
mᵢ=[|wᵢ₁|², |wᵢ₂|², . . . |w_{id}|²], wᵢₛ denotes a vector formed by weights over an ith channel of the sth convolution kernel of the plurality of convolution layers, s=1, 2, . . . , d, and
maintaining the vector λ when |ξ| is less than or equal to M.6. The method of claim 1, further comprising:
before inputting the corrected computation result into the nonlinear layers of the neural network model, limiting the corrected computation result to being between a first threshold and a second threshold by, when the corrected computation result is less than the first threshold, updating the corrected computation result to the first threshold, and when the corrected computation result is greater than or equal to the second threshold, updating the corrected computation result to the second threshold,
wherein the first threshold and the second threshold are based on parameters of a batch normalization (BN) layer corresponding to the plurality of convolution layers.

6. The method of claim 1, further comprising:
before inputting the corrected computation result into the nonlinear layers of the neural network model, limiting the corrected computation result to being between a first threshold and a second threshold by, when the corrected computation result is less than the first threshold, updating the corrected computation result to the first threshold, and when the corrected computation result is greater than or equal to the second threshold, updating the corrected computation result to the second threshold,
wherein the first threshold and the second threshold are based on parameters of a batch normalization (BN) layer corresponding to the plurality of convolution layers.

7. The method of claim 6, wherein the first threshold is d and the second threshold is u,
wherein d=−kγ+β, u=kγ+β, and
wherein γ and β are parameters of the BN layer corresponding to the plurality of convolution layers, and k is a preset value.

8. The method of claim 6, wherein the IRP noise causes a correlation between the computation result in the REE and a corresponding output of the nonlinear layer to which the IRP noise has been applied to be less than a predetermined value.

9. The method of claim 8, wherein the IRP noise applied to the output of the nonlinear layer is e and is obtained based on the following equation:
$$e = r + c ,$$
wherein respective elements of r are independent from each other and follow an identical distribution, and r is Gaussian white noise with a mean of 0 and a variance of not less than Dₘᵢₙ,
$${D}_{min} = ( \frac{1}{{ρ}_{x , y}^{2}} - 1 ) \cdot {( \frac{b - a}{2} )}^{2} ,$$
wherein c denotes random samples on an interval [a,b], and
wherein ρ_{x,y} is a preconfigured Pearson's correlation coefficient, a is obtained by mapping the first threshold through a nonlinear layer, and b is obtained by mapping the second threshold through the nonlinear layer.

10. The method of claim 1, wherein τ is a vector of the IRP noise correction factors corresponding to the remaining convolution layers,
wherein τ=Conv(e, Ŵ), and
wherein e denotes IRP noise applied to an output of a nonlinear layer corresponding to a previous layer of remaining convolution layers, and Ŵ denotes weights of convolution kernels of the remaining convolution layers that have been perturbed.

11. A neutral network model inference device comprising:
at least one first memory that stores first computer code;
at least one first processor that accesses the at least one first memory and executes the first computer code to implement at least computing module configured to perform, in a rich execution environment (REE), computation for each of a plurality of convolution layers of a neural network model, based on multiplicative perturbation factors of the convolution layer and output a computation result of each of the plurality of convolution layers to a trusted execution environment (TEE);
at least one second memory in a trusted execution environment (TEE) that stores second computer code; and
at least one second processor in the TEE that accesses the at least one second memory in the TEE and executes the second computer code in the TEE to implement at least:
a correcting module configured to, in the trusted execution environment (TEE), correct the computation result of a first convolution layer of the plurality of convolution layers based on the multiplicative perturbation factors corresponding to the first convolution layer, and correct the computation result of each of remaining convolution layers other than the first convolution layer among the plurality of convolution layers based on the multiplicative perturbation factors and intermediate result protection (IRP) noise correction factor corresponding to the remaining convolution layer;
an inputting module configured to, in the TEE, input the corrected computation result of the plurality of convolution layers into corresponding nonlinear layers of the neural network model; and
an applying module configured to, in the TEE, apply IRP noise to an output of the nonlinear layers corresponding to each of the plurality of convolution layers other than a last layer among the plurality of convolution layers, and output the nonlinear layer to which the IRP noise has been applied to the REE,
wherein the IRP noise correction factors are based on IRP noise applied to the output of the nonlinear layer corresponding to a previous convolution layer of the remaining convolution layers, and
wherein an output of a last nonlinear layer of the neural network model is an inference result of the neural network model.

12. The neutral network model inference device of claim 11, wherein the multiplicative perturbation factors of each of the plurality of convolution layers are obtained by
determining a vector λ=[λ₁, λ₂, . . . , λ_{d}] of the multiplicative perturbation factors corresponding to convolution kernels of the plurality of convolution layers, the multiplicative perturbation factors in the vector λ having a distribution defined by:
$$E [ {λ}_{s} ] = 0 ,$$
$$Var [ {λ}_{s} ] = \frac{{G}^{2} \cdot {D}_{t}}{{max}_{i} {\vert {w}_{i} \vert}^{2}} ,$$
wherein d denotes a number of the convolution kernels of the plurality of convolution layers, E[λₛ] and Var[λₛ] denote a mean and a variance, respectively, of an sth multiplicative perturbation factor in the vector λ, G denotes an activation function gain value, Dₜ denotes an expected attenuation of a gradient variance as the gradient variance propagates backward in the plurality of convolution layers, and wᵢ denotes a vector formed by weights over channels of an ith convolution kernel in W, and W denotes a weight matrix for all convolution kernels of the plurality of convolution layers, s=1, 2, . . . , d; and
obtaining perturbed weights and perturbed biases of the convolution kernels of the plurality of convolution layers by performing multiplicative perturbation on actual weights and actual biases of the convolution kernels based on the vector λ.

13. The neutral network model inference device of claim 12, wherein before obtaining the perturbed weights and the perturbed biases, the actual weights and the actual biases of the convolution kernels are updated based on actual parameters of the plurality of convolution layers and parameters of a batch normalization (BN) layer corresponding to the plurality of convolution layers of the neural network model; and
after the actual weights and the actual biases are updated, the BN layer is deleted or the parameters of the BN layer are initialized.

14. The neutral network model inference device of claim 13, wherein the updated weights and the updated biases are based on the following equations:
$$\tilde{W} = \frac{γ W}{\sqrt{{σ}^{2} + ϵ}} , \tilde{B} = β J + γ \frac{B - μ J}{\sqrt{{σ}^{2} + ϵ}} ,$$
wherein \tilde{W} denotes the updated weights, \tilde{B} denotes the updated biases, W and B denote the actual weights and the actual biases, respectively, of the convolution kernels, γ, β, μ, σ and ϵ are the parameters of the BN layer, and J denotes an all-ones matrix.

15. The neutral network model inference device of claim 12, wherein:
a modulus |ξ| of a vector ξ formed by squares of the multiplicative perturbation factors in the vector λ are calculated; and
the vector λ is updated to be
$$λ \cdot \sqrt{\frac{M}{\vert ξ \vert}}$$
when |ξ| is greater than M, wherein
$$M = \frac{{G}^{2} \cdot {D}_{t}}{{max}_{i} \vert {m}_{i} \vert} ,$$
mᵢ=[|wᵢ₁|², |wᵢ₂|², . . . |w_{id}|²], wᵢₛ denotes a vector formed by weights over an ith channel of an sth convolution kernel of the plurality of convolution layers, s=1, 2, . . . , d, and
the vector λ is maintained when |ξ| is less than or equal to M.

16. The neutral network model inference device of claim 11, wherein the at least one second processor in the TEE accesses the at least one second memory in the TEE and executes the second computer code in the TEE to further implement a limiting module that, before the corrected computation result is input into the nonlinear layers of the neural network model, limits the corrected computation result to being between a first threshold and a second threshold by, when the corrected computation result is less than the first threshold, updating the corrected computation result to the first threshold, and when the corrected computation result is greater than or equal to the second threshold, updating the corrected computation result to the second threshold.

17. The neutral network model inference device of claim 16, wherein the first threshold is d and the second threshold is u,
wherein d=−kγ+β, u=kγ+β, and
wherein γ and β are parameters of a batch normalization (BN) layer corresponding to the plurality of convolution layers, and k is a preset value.

18. The neutral network model inference device of claim 16, wherein the IRP noise causes a correlation between the computation result in the REE and an output of the nonlinear layer to which the IRP noise has been applied to be less than a predetermined value.

19. The neutral network model inference device of claim 18, wherein the IRP noise applied to the output of the nonlinear layer is e and is obtained based on the following equation:
$$e = r + c ,$$
wherein respective elements of r are independent from each other and follow an identical distribution, and r is Gaussian white noise with a mean of 0 and a variance of not less than Dₘᵢₙ,
$${D}_{min} = ( \frac{1}{{ρ}_{x , y}^{2}} - 1 ) \cdot {( \frac{b - a}{2} )}^{2} ,$$
wherein c denotes random samples on an interval [a,b], and
wherein ρ_{x,y} is a preconfigured Pearson's correlation coefficient, a is obtained by mapping the first threshold through a nonlinear layer and b is obtained by mapping the second threshold through the nonlinear layer.

20. (canceled)

21. A non-transitory computer readable storage medium storing a computer program that when executed by at least one processor causes the at least one processor to at least:
perform, in a rich execution environment (REE), computation for each of a plurality of convolution layers of a neural network model, based on multiplicative perturbation factors of the convolution layer and output a computation result of each of the plurality of convolution layers to a trusted execution environment (TEE); and
in the trusted execution environment (TEE):
correct the computation result of a first convolution layer of the plurality of convolution layers based on the multiplicative perturbation factors corresponding to the first convolution layer,
correct the computation result of each of remaining convolution layers other than the first convolution layer among the plurality of convolution layers based on the multiplicative perturbation factors and intermediate result protection (IRP) noise correction factors corresponding to the remaining convolution layers,
input the corrected computation result of the plurality of convolution layers into corresponding nonlinear layers of the neural network model, and
applying IRP noise to an output of the nonlinear layer corresponding to each of the plurality of convolution layers other than a last convolution layer among the plurality of convolution layers, and
outputting the nonlinear layer to which the IRP noise has been applied to the REE,
wherein the IRP noise correction factors are based on IRP noise applied to the output of the nonlinear layer corresponding to a previous convolution layer of the remaining convolution layers, and
wherein an output of a last nonlinear layer of the neural network model is an inference result of the neural network model.
